(19) United States
(12) Patent Application Publication
(10) Pub. No.: US 2010/0266875 A1
(43) Pub. Date: Oct. 21, 2010

(54) Fuel Cell Power Management Module

(76) Inventors: Ryan Somogye, Dublin, OH (US); Gabe J. Stout, Columbus, OH (US); David C. Diedling, Liberty Township, OH (US); Todd A. McCandlish, Columbus, OH (US); Douglas A. Thornton, Upper Arlington, OH (US)

Correspondence Address: MACMILLAN, SOBANSKI & TODD, LLC, ONE MARITIME PLAZA-FIFTH FLOOR, 720 WATER STREET, TOLEDO, OH, 43604, US

(21) Appl. No.: 12/514,396

(22) PCT Filed: Nov. 13, 2007
(86) PCT No.: PCT/US07/23744

§ 371 Date: Jun. 10, 2010

Related U.S. Application Data
(60) Provisional application No. 60/858,606, filed on Nov. 13, 2006.
(60) Provisional application No. 60/964,074, filed on Aug. 9, 2007.

(51) Int. Cl. H01M 8/04

(52) U.S. Cl. 429/7; 429/431

(57) ABSTRACT

A power management module adapted to be connected between a fuel cell and an output power bus, the power management module being operative to regulate the amount of power being delivered by the fuel cell to the output power bus.

### BACKGROUND OF THE INVENTION

This invention relates in general to fuel cells and in particular to a fuel cell power management module.

A fuel cell is an electrochemical device that converts chemical energy produced by a reaction directly into electrical energy. For example, one type of fuel cell includes a Proton Exchange Membrane (PEM), often called a polymer electrolyte membrane, that permits only protons to pass between an anode and a cathode of the fuel cell. At the anode, diatomic hydrogen, which is a fuel, is reacted to produce hydrogen protons that pass through the PEM. The electrons produced by this reaction travel through circuitry that is external to the fuel cell to form an electrical current. At the cathode, oxygen is reduced and reacts with the hydrogen protons to form water.

A typical fuel cell has a terminal voltage that is approximately one volt DC. For purposes of producing much larger voltages, several fuel cells may be assembled together to form an arrangement called a fuel cell stack, an arrangement in which the fuel cells are electrically coupled together in series to form a larger DC voltage, such as a voltage near 100 volts DC, for example, and to provide a larger amount of power.

The fuel cell stack may include flow plates, such as graphite composite plates or metal plates, as examples, that are stacked one on top of the other, and each plate may be associated with more than one fuel cell of the stack. The flow plates may include various surface flow channels and orifices to route the reactants and products through the fuel cell stack. Several PEMs, with each PEM being associated with a particular fuel cell, may be dispersed throughout the fuel cell stack between the anodes and cathodes of the individual fuel cells.

The fuel cell stack may be part of a fuel cell system that supplies power to a load, such as a vehicle, for example. A fuel cell system also may include, among its various components, an inverter to convert the DC voltage that is furnished by the stack into AC voltages that may be furnished to an application requiring alternating current. The fuel cell system may also include a reformer to convert a hydrocarbon, such as natural gas, propane or diesel fuel, as examples, into a hydrogen gas flow. The hydrogen gas flow needs to be large enough to satisfy the current flow demand placed upon the fuel cell system by the electrical load. Therefore, higher current levels require larger flow rates and thus, require more hydrogen production by the reformer.

The fuel cell system typically monitors the output power of the system and regulates the production of the reformer based on the monitored power. Thus, an increased power demand from the load typically requires an increase in the production by the reformer. A conventional reformer may have a relatively slow transient response that causes any increase in production to significantly lag the increased demand for power. As a result, when the power that is demanded by the supplied system suddenly increases, the fuel cell stack may “starve” due to the lack of a sufficient hydrogen flow until the production of hydrogen by the reformer increases to the appropriate level. This fuel starvation, in turn, may damage fuel cells of the stack. Accordingly, it would be desirable to provide a device to efficiently manage the power generated by a fuel cell.

### SUMMARY OF THE INVENTION

This invention relates to a fuel cell power management module.

The present invention contemplates a control circuit for management of a fuel cell that includes at least one sensor adapted to be in communication with the fuel cell and operative to monitor an operating condition of the fuel cell. The control circuit also includes a regulator circuit connected to the sensor that is operative to generate a control signal that is a function of the senor output signal. The control circuit further includes a current regulation circuit that is adapted to be connected between the fuel cell and a load with the current limiter circuit connected to the regulator circuit to receive the control signal. The current regulation circuit being responsive to the control signal to regulate the operation of the fuel cell.

It is further contemplated that the sensor is operative to determine the rate of fuel delivery to the fuel cell and that the current regulation circuit includes at least one pulse width modulated current limiter circuits. The pulse width modulated current limiter circuit being operative to limit the current flowing to the load as a function of a voltage offset such that the load current does not exceed the capability of the fuel cell being supplied at the sensed fuel supply rate.

The invention also contemplates an alternate embodiment of the control circuit in which the sensor is operative to monitor at least one of the current or output voltage supplied by the fuel cell. The alternate embodiment also includes a current regulation circuit having a dc to ac converter connected to the regulator circuit, the converter having a dc input adapted to be connected to the fuel cell and an ac output. The current regulation circuit also includes a transformer having a primary winding and a secondary winding with the primary winding connected to the ac output of the dc to ac converter. The current regulation circuit further includes an ac to dc converter connected to the regulator circuit and having an ac input connected to the secondary winding of the transformer and a do output adapted to be connected to a load.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 illustrates a Fuel Cell System that includes a Power Management Module (PMM) that is in accordance with the present invention.

FIG. 2 is a schematic circuit diagram illustrating the switching topology for the PMM shown in FIG. 1.

FIG. 3 is a block diagram illustrating the major components and isolation barriers for the PMM shown in FIG. 1.

FIG. 4 is a flow chart of a phase-shifted PWM control algorithm that is utilized for the PMM shown in FIG. 1.

FIG. 5 illustrates an ATR VME enclosure that receives a plurality of the PMM shown in FIG. 1.

FIG. 6 is a plan view of the PMM that is shown in FIG. 1.

FIG. 7 is a side view of the PMM that is shown in FIG. 1.

FIG. 8 is an assembled perspective view of the PMM that is shown in FIG. 1.

FIG. 9 is a heat flow diagram for the PMM shown in FIG. 1.

FIG. 10 illustrates an alternate embodiment of the PMM shown in FIG. 1.

FIG. 11 is a block diagram that illustrates the overall operation of the alternate embodiment of the PMM shown in FIG. 10.

FIG. 12 is a circuit diagram for a portion of the control circuit for the PMM shown in FIG. 10.

FIG. 13 is another circuit diagram for a portion of the control circuit for the PMM shown in FIG. 10.

### DETAILED DESCRIPTION OF THE PREFERRED EMBODIMENT

Damage to a fuel cell stack can occur by exceeding the maximum level of electrical current draw possible with the available amount of hydrogen. Fuel cell systems where hydrogen is reformed from liquid fuels, such as diesel, require an intelligent power management system to prevent damage to the fuel cell. Such a power management system is required to act as a buffer limiting the maximum current demand placed on the fuel cell. The present invention provides a solution to this problem with a Power Management Module (PMM) that supplements the fuel cell by dynamically limiting the electrical current demands placed on it to levels which would not cause damage. The PMM of the present invention includes intelligent electronics designed for coordinated responses between a fuel processor, fuel cell stack and an associated electrical load while reducing redundancy of critical functions. The PMM also includes a modular design that allows employment of the Fuel Cell to achieve application flexibility and provide redundancy while being applicable to other power systems that have either higher or lower power ratings. The present invention also contemplates a functional PMM that safely controls the flow of power from fuel cells. The PMM also may be utilized with other current-limited alternative energy sources, such as, for example, a photovoltaic energy source.

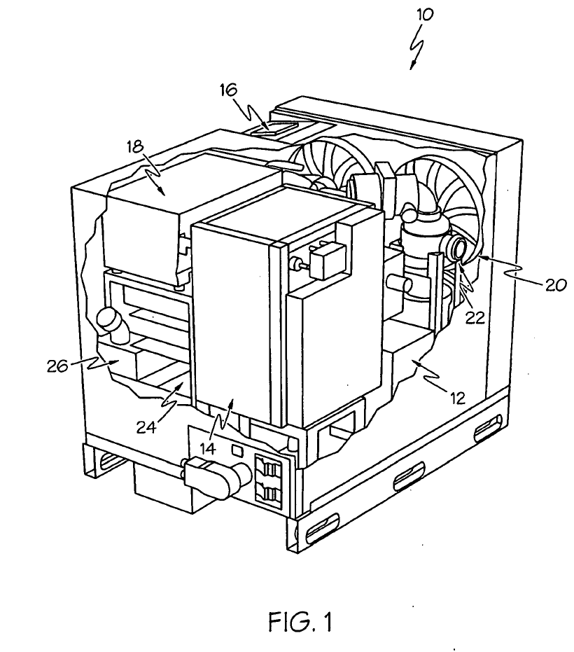

Referring now to the drawings, there is illustrated in FIG. 1 a fuel cell modular system 10, or Multipurpose Electric Power Supply (MEPS), that is made up of a plurality of modules. The modular system 10 includes a PMM 12 that is in accordance with the present invention and that enables maximum implementation flexibility. The overall modular system 10 and associated subassemblies have been designed for unproved cooling water management. The fuel cell modular system 10 also includes an integrated fuel processing subassembly 14, or module, for conversion of diesel fuel to hydrogen; however, other fuels also may be utilized. The fuel cell modular system 10 further includes a plurality of individual modules that reduces the total size and weight of the system while enabling a highly portable power supply. Thus, the fuel cell modular system 10 includes intelligent electronics 16 designed for coordinated responses between the fuel processor 14, a fuel cell stack 18 and an associated electrical load while reducing redundancy of critical functions. Also included in the fuel cell modular system 10 shown in FIG. 1 are cooling and air management modules, 20 and 22, respectively, and fuel and water management and storage modules, 24 and 26, respectively. The modular design allows employment fuel cells to achieve application flexibility.

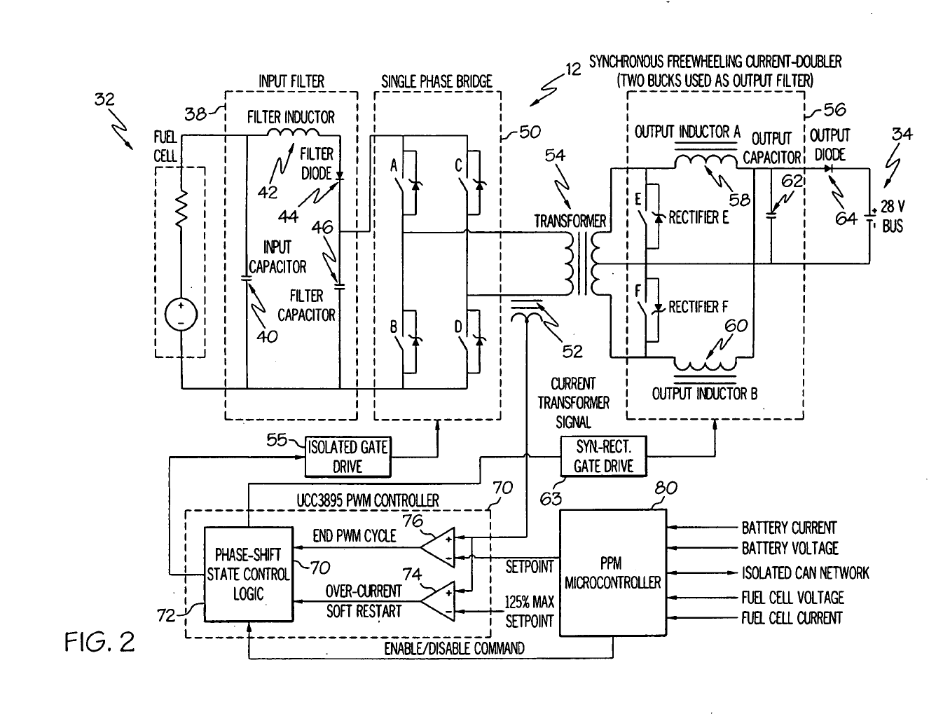

A schematic circuit diagram for the PMM 12, or subassembly, is shown in FIG. 2. The PMM 12 is contemplated as being a compact water-cooled assembly that interfaces between a variable fuel cell voltage and most battery bus systems while providing a coordinated response to the fuel cell output current and voltage and output bus current and voltage to manage the fuel cell system. The modular design of the PMM 12 provides redundancy while being applicable to other power systems that have either higher or lower power ratings. While the PMM 12 has been described above as being water cooled, it will be appreciated that the PMM also may be configured to be air cooled (not shown).

The present invention contemplates that the PMM 12 is a switching regulator with special control circuitry allowing for an adjustable current-limiting level. The PMM 12 is intended to provide a size-efficient and scalable solution to a fuel cell while maintaining a high level of versatility in its application. The switching regulators are mounted upon a backplane holding input and output bus conductors and a cooling assembly. Paralleling the switching regulators makes it possible to scale the power levels of a system to nearly any level. Incorporating redundant regulators into the design of the PMM 12 also allows for higher reliability requirements to be achieved while connecting the same switching regulators into configurable backplanes which allow for a far greater range in mechanical versatility by making a wide variety of cooling options to become available, i.e., fluid, heat pipes, or convection. Also, mechanical packaging options are expanded. For example, the overall size of a PMM 12 for a 7 kW Fuel Cell is approximately 10.5″H×8.5″W×8.5″L, which is about 10 W per cubic inch power density. The PMM 12 shown in FIG. 1 illustrates a packaged four regulator PMM. Each module is independently controlled and capable of an output of 62 A for a total power output of 250 A at up to a 28 VDC output bus/battery charging level. The total power output of the module is up to 71 kW.

The schematic circuit diagram of FIG. 2 shows the overall design of the PMM 12 with the input of the PMM connected to the output of a single fuel cell 32. The fuel cell 32 includes an integrated fuel processing subassembly, or module, for conversion of diesel fuel to hydrogen; however, other fuels also may be utilized, such as, for example, natural gas or propane. The fuel cell 32 may include a plurality of individual modules that reduces size and weight of the cell while enabling a highly portable power supply. The output of the PMM 12 is shown as connected to a 28 volt battery bus 34; however, the PMM output also may have a different magnitude than that which is shown. As described above, a plurality of PMM's may be assembled in parallel (not shown) to control a corresponding plurality of fuel cells (not shown) to increase the total power output to the fuel cell modular system 10.

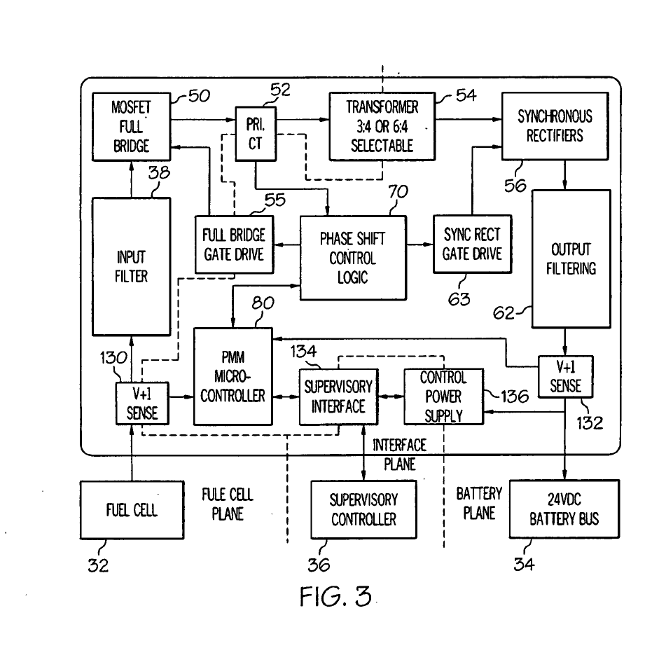

The PMM 12 is a DC to DC converter that regulates the electrical current supplied by the fuel cell 32 in accordance with an external command received from a supervisory control unit 36 which is shown in FIG. 3. The PMM 12 serves three primary functions within the fuel cell modular system 10, namely:
To transfer power from the fuel cell, at its voltage level, which may vary, to the 28 VDC battery bus 34;
To regulate the amount of power transferred from the fuel cell 32 to the battery bus 34; and
To monitor voltage and current on both the input from the fuel cell 32 and the output to the battery bus 34 of the fuel cell modular system 10.

The PMM 12 uses a full-bridge switching topology to transfer power from the fuel cell 32 to the battery bus 34. The PMM 12 is capable of transferring power in only one direction from the input to the output, that is, the PMM 12 is not capable of loading the battery bus 34 to transfer power into the fuel cell 32. This backward power transfer is not a useful operating condition of the fuel cell or the fuel cell modular system 10. The PMM 12 is intended for use with a battery bus and, therefore, draws its power for operating the control circuitry from this battery bus.

The fuel cell output is fed into an input filter 38 of the PMM 12, consisting of an input capacitor 40 that is connected in parallel across a series connection of a filter inductor 42, a filter diode 44 for blocking reverse current flow, and a filter capacitor 46. The purpose of the input filter 38 is to soften the current pulses seen by the fuel cell as the PMM 12 switching takes place. With normal operation, the fuel cell 32 is subjected to periods of large current draw while the bridge switches are on and zero current draw while the bridge switches are off. This cycle repeats at the PMM's switching frequency. Rapid changes in current draw from the fuel cell 32, or any electrical source, can lead to electromagnetic noise being radiated by the electrical cables. The input filter 38 serves to smooth the current drawn from the fuel cell so that the instantaneous current is close to the average current, thus reducing current ripple, which is defined as the difference between peak and average current, while also reducing the radiated noise. The output of the input filter 38 is taken across the filter capacitor 46, which is connected to the input terminals of a single phase bridge circuit 50.

The filter capacitor 46 provides a stable voltage to power the single phase bridge circuit 50. The output of the bridge circuit 50 is connected through a current sensing transformer 52 to the primary winding of an isolation transformer 54. The bridge circuit 50 includes four electronic switches, which, for the embodiment shown in FIG. 2, are MOSFET's, that are labeled A, B, C, and D. Each of the MOSFET's has an integrated reverse-biasing diode that is shown as a Zener diode in FIG. 2. While MOSFET's are shown in FIG. 2, it will be appreciated that other electronic switching devices also may be utilized in the PMM 12. Each of the six switches A, B, C, D, E and F in the PMM circuit also contains snubbers, or resistor-capacitor-diode networks (not shown) to quench voltage transients inherent in the fast switching of transistors. These snubbers serve to reduce the overall switching losses and radiated EMI noise by dampening voltage oscillations and limiting the rate of rise of the voltage across the switch. The switches A, B, C, and D are controlled by a gate drive circuit 55.

The switch configuration of the bridge circuit 50 is able to selectively apply the fuel cell voltage in one of a positive polarity, a reverse polarity, an open circuit, and a short to generate an approximate AC voltage waveform for application to the input of the isolation transformer 54. The duty cycle and frequency of the generated AC voltage waveform is determined by the control logic of the PMM 12, but the peak magnitude is always the fuel cell voltage after being filtered by the PMM input filter 38. In this way, the PMM 12 uses a phase-shifted pulse-width-modulated control method, as will be discussed below, to vary the average voltage on the transformer's primary winding and thereby determine the amount of power transferred from the fuel cell 32 to the battery bus 34.

The use of an isolation transformer 54 in the PMM 12 is important for the following reasons:
it allows the fuel cell 32 to be electrically isolated from the battery bus 34 for safety and electromagnetic interference (EMI) reduction purposes, and;
it allows the trading of voltage for current, and vice versa, by means of the isolation transformer turns ratio to best match a particular fuel cell voltage range to the applicable battery bus voltage range.

Electrical isolation also provides an additional margin of safety by ensuring that there is no continuous conductive path connecting the fuel cell 32 to the battery bus 34. This lowers the risk of the fuel cell modular system 10 user being exposed to a potential high voltage generated by the fuel cell. Electrical isolation also helps to reduce EMI by preventing induced currents from circulation between individual PMM modules. Finally, appropriate selection of the primary-to-secondary turns ratios of the transformer allows the fuel cell output voltage to be higher, lower, or to overlap the voltage on the battery bus. The isolation transformer 54 further makes the PMM's switching topology easily reconfigurable to changes in fuel cell models, battery bus output voltages, or both.

The PMM 12 further includes an output filter 56 that is connected across the output terminals of the transformer 54. The output filter 56 consists of a pair of rectifying electronic switches which are labeled E and F that are connected in series across the transformer output. The rectifying electronic switches E and F are again shown as MOSFET's with integrated reverse-biasing diodes; however, other electronic devices also may be utilized. The output filter 56 also includes a pair of output inductors 58 and 60, with each conductor connected to one end of a corresponding switch E and F, respectively. The other end of each of the output inductors 58 and 60 is connected to one end of an output capacitor 62. The other end of the output capacitor 62 is connected to a common point between the electronic switches E and F. The electronic switches E and F are controlled by a synchronizing rectifier gate drive circuit 63. Each rectifying electronic switch and associated output inductor is configured as a buck-type filter.

The two output inductors 58 and 60 are alternately charged by the output of the isolation transformer 54 as the voltage on the isolation transformer secondary coil reverses polarity. This periodic polarity reversal is a reflection of the input waveform, from the single-phase bridge 50, through the turn ratio of the isolation transformer 54. While the one output inductor is charging, the other is freewheeling through the rectifying electronic switches E and F, and vice versa. When the input of the isolation transformer 54 is shorted or open-circuited by the bridge circuit 50, both of the output inductors 58 and 60 are free-wheeling through their respective electronic switches E and F. Both buck filters serve to charge the same output capacitor 62, which provides filtering for the output of the PMM 12. As shown in FIG. 2, the output capacitor 62 is connected across the battery bus 34. The PMM 12 further includes an output diode 64 that provides protection against current flowing backward from the battery bus 34 into the PMM's output capacitor 62.

The PMM 12 further includes a Pulse-Width-Modulating (PWM) phase-shifting control circuit 70, which is shown in FIG. 2 as a Texas Instruments UCC3895 microprocessor chip, that implements peak current control to directly regulate the output current of the PMM. While a Texas Instruments UCC3895 microprocessor chip is shown in FIG. 2, it will be appreciated that the invention also may be practiced with other control devices. The shifting control circuit 70 is connected to the gate driver 55 for the electronic switches A, B, C and D and to the gate driver 63 for the electronic switches E and F and includes a phase shift control logic circuit 72 that receives cycle starting and ending signals from first and second comparators 74 and 76, respectively. Both of the comparators 74 and 76 receive an isolation transformer primary coil current signal from the current transformer 52. The first comparator 74 compares the primary current to a predetermined setpoint, while the second comparator 76 compares the primary current to a setpoint received from a PMM microcontroller 80 that, in turn, receives signals from the supervisory controller 36 over a CAN network. As shown in FIG. 2, the PMM microcontroller 80 also receives signals representing the output voltage and current of the fuel cell 32 and current and voltage data from the battery bus 34.

FIG. 3 is a block diagram showing the arrangement of the major components of the PMM 12 and the fuel cell 32, battery bus 34, and supervisory controller 36. Components shown in FIG. 3 have the same numerical identifiers as the components shown in FIG. 2. The PMM 12 is easily reconfigurable to support a wide range of voltage-current constant-power combinations and is designed specifically with the capability to work with fuel cells from multiple manufacturers, each of which may supply electrical power within a different voltage range. Thus, the isolation transformer 54 can be exchanged for another unit having a different primary-secondary turn ratio. The transistor switches in the single-phase bridge 50, along with all the components of the input filter 38, may be changed to substitute components having different voltage and current ratings, thus making it extremely easy to adapt the PMM 12 to a different input voltage range and a new fuel cell. In the same manner, the synchronous rectifiers and output filter 56 are also constructed of interchangeable components to accommodate any need for changing the battery bus voltage. Therefore, the PMM 12 can be implemented with a variety of input-output voltage range combinations without the need for a full redesign or another board layout.

The PMM 12 also has three-way electrical isolation, as illustrated by FIG. 3. All three electrical planes, fuel cell input, battery bus output, and communication and control lines, are isolated from one another as shown by the dashed lines in FIG. 3. The electrical isolation provides two major advantages: safety and Electro-Magnetic Interference (EMI) noise reduction. In the event of a component failing into an on-state, the high voltage of the fuel cell will not appear on the battery bus or the communication lines. Electrical isolation also aids in the mitigation of EMI by preventing current from circulation between individual PMM cards. Since power transmitted from input to output is magnetically, not electrically, coupled by the transformer 54, the current leaving the PMM card must be the same as the current entering the PMM card only when the isolation transformer has a 1:1 turns ratio. This restriction also allows for filtering of the input current so that the PWM cycle frequency or its components are not transmitted into the input or output cables. Otherwise, the cable would act as an antenna and radiate the pulsating current as EMI noise.

The operation of the PMM 12, which utilizes a closed-loop peak current control, will now be described. At the start of each PWM cycle, the filtered fuel cell voltage is applied to the primary coil of the isolation transformer 54 by the single-phase bridge 50. The current transformer 52 measures the instantaneous current flowing into the primary coil of the isolation transformer 52 by reflecting 1/200^{th} of the actual current into a full-wave rectifier and load resistor (not shown) that is connected to the positive input terminals of the first and second comparators 74 and 76. The voltage waveform, or the current measurement signal, appearing on the load resistor is compared by the second comparator 76 to a set point voltage value that is generated by the microcontroller 80 and a digital-to-analog converter (not shown). When the current measurement signal exceeds the set point voltage, the single-phase bridge removes the fuel cell voltage and shorts the transformer primary for the remainder of the PWM half-cycle. The UCC3895 PWM controller 70 then reverses the polarity of the voltage applied to the isolation transformer primary with each successive half-cycle, thus producing an AC voltage and preventing saturation of either the isolation transformer 54 or the current sensing transformer 52.

The UCC3895 implements a specific state-based cycle that phase-shifts the two half-bridge pairs of transistors, i.e., A and D, and C and B, in the bridge 50. Each transistor (high side and low side) of a half-bridge alternate their state once per PWM cycle. Each transistor, not including a small built-in delay to prevent current shoot-through, is on for 50% of the PWM cycle. To adjust the duty cycle seen by the transformer primary, the UCC3895 varies the amount of time that one half-bridge is conducting high and the other half-bridge is conducting low. In this way, the phase difference between the two half-bridges is increased to increase the effective transformer duty cycle. When the phase difference is zero, the isolation transformer primary sees a duty cycle of zero and no power flows. When the phase shift is at a maximum of 180 degrees, the transformer primary sees a 100% duty cycle. Normal PWM converters have minimum and maximum duty cycle limits, usually imposed by the method of driving the gate of the transistor switches. The phase shifting method utilized by the present invention maintains a 50% duty cycle on each switch while implementing a zero to near 100% duty cycle on the isolation transformer 54.

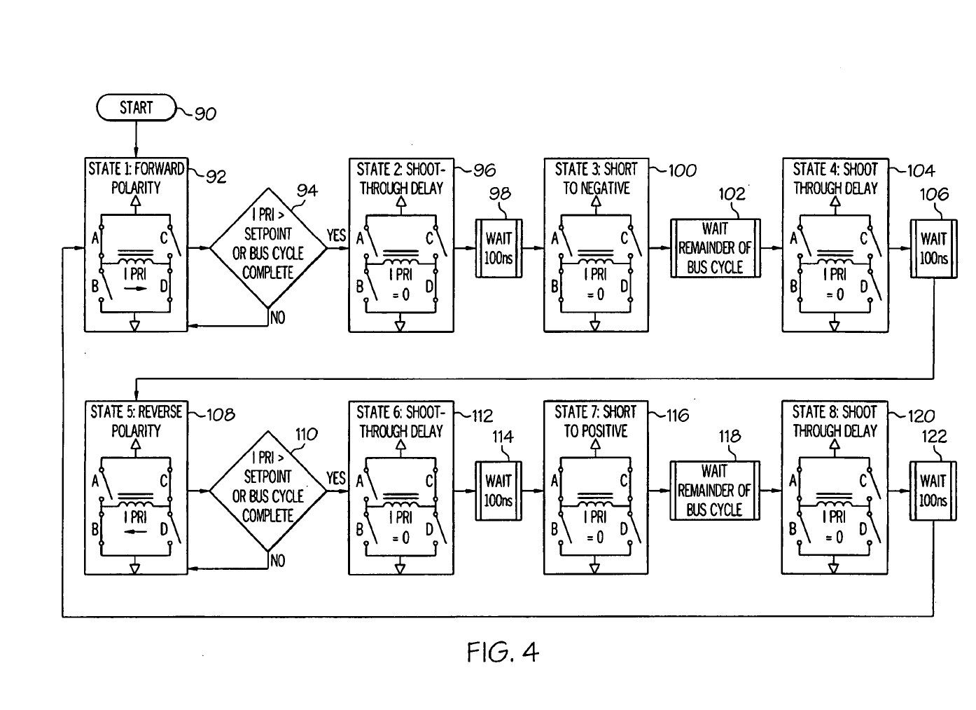

The operation of the PMM 12 is under control of a state-based switching algorithm that is illustrated by the flow chart shown in FIG. 3. For clarity, the flow chart presents a graphical representation of the condition of the switches A, B, C and D in the functional blocks that concern changing the conducting states of the switches. The flow chart is entered through block 90 and proceeds to functional block 92 where one pair of half-bridge switches A and D are closed and the other pair of half-bridge switches B and C are opened to allow a primary current to flow in one direction through the transformer primary coil. The algorithm then continues to decision block 94 where the primary current is compared to a current set point and the duration of the on time for switches A and D is checked. If either the primary current is less than the current set point or the duration of the on time for switches A and D is less than a half-cycle duration, the algorithm returns to functional block 92. If, however, either the primary current is greater than or equal to the current set point or the duration of the on time for switches A and D is greater than or equal to the half-cycle duration, the algorithm advances to functional block 96. As shown in decision block 94, the half-cycle duration is 5 μsec; however, the invention also may be practiced with other half-cycle duration times than that shown in FIG. 4.

In functional block 96, switch A is opened for a first shoot through delay with switch D connecting the low side of the primary coil to ground. The delay is timed in functional block 98 as having a 100 nsec duration, however, other delay lengths may be utilized. The algorithm then advances to functional block 100 where switch B is closed, shorting the primary coil to ground to remove any current from the coil before the polarity is reversed. The algorithm then advances to functional block 102 where the shorted primary coil condition is maintained for the remainder of the positive cycle. The algorithm then continues to functional block 104.

In functional block 104, switch D is opened for a second shoot through delay of 100 nsec, as shown by functional block 106. The algorithm continues to functional block 108 where the flow of current is resumed through the transformer primary coil in the opposite direction by closing switch C. The algorithm then proceeds to decision block 110 where the primary current is again compared to the current set point and the duration of the on time for switches A and D is checked. If either the primary current is less than the current set point or the duration of the on time for switches B and C is less that a half-cycle duration, the algorithm returns to functional block 108. If, however, either the primary current is greater than or equal to the current set point or the duration of the on time for switches B and C is greater than or equal to the half-cycle duration, the algorithm advances to functional block 112. As shown in decision block 110, the half-cycle duration is again 5 μsec; however, the invention also may be practiced with other half cycle duration times than shown in FIG. 4.

In functional block 112, switch B is opened for a first shoot through delay with switch C connecting the low side of the primary coil to ground. The delay is timed in functional block 114 as having a 100 nsec duration, however, other delay lengths may be utilized. The algorithm then advances to functional block 116 where switch A is closed, shorting the primary coil to ground to remove any current from the coil before the polarity is reversed. The algorithm then advances to functional block 118 where the shorted primary coil condition is maintained for the remainder of the positive cycle. The algorithm then continues to functional block 120.

In functional block 120, switch C is opened for a second shoot through delay of 100 nsec, as shown by functional block 122, to complete the cycle. The algorithm then returns to functional block 92 to begin the next cycle. For the values shown in FIG. 4, the dual States shown in blocks 92 and 108 can last for a maximum of 5 us. In this condition, the switching topology is fully on and is transferring as much power from the input to output as possible. On the other hand, the transition states shown in blocks 96, 100, 104 and 112, 116, 120 are of negligible time length in this condition.

While the UCC3895 in the PWM controller 70 implements a closed-loop control on the output current from the PMM 12, the microcontroller 80 is required to close the loop on input current from the fuel cell output while also providing battery bus or fuel cell voltage regulation. As shown in FIG. 3, the PMM 12 contains voltage and current sensors 130 on the fuel cell input terminals and voltage and current sensors 132 on the battery bus output terminals. These voltage and current sensors 130 and 132 do not pick up any of the PWM cycle current or voltage oscillations and thus are appropriate for controlling current and voltage with loop times much longer than the PWM cycle.

The PMM microcontroller 80 accepts commands from the supervisory controller 36 via a Communication Area Network (CAN) through a supervisory interface 134, as shown in FIG. 3. These commands include selecting a control parameter, such as, for example, fuel cell voltage or current, battery bus voltage or current, the control parameter set point, and then limits for the measured parameters. The PMM microcontroller 80 selects an appropriate closed-loop or open-loop control method to regulate the selected parameter to the set point. The invention also contemplates that the PMM 12 provides power to the supervisory interface 134 and supervisory controller though a control power supply 136 as also shown in FIG. 3.

The invention further contemplates that the PMM board layout and physical packaging takes advantage of the VersaModular Eurocard (VME) card bus standard that is often used for computers and embedded systems in military applications. Multiple manufacturers supply circuit cards, enclosures, and accessories that comply with the VME standard. Like any standard, this assures that components from different manufacturers will function correctly together and maintain their electrical, shock, vibration, temperature, etc. ratings.

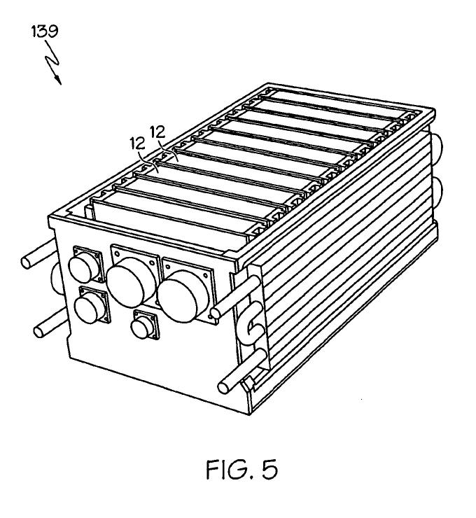

The VME standard has two parts to its technical definition; physical dimensions and electrical signal specifications. The PMM 12 uses only the mechanical dimension specifications and therefore, requires a custom backplane that is added to a commercially available case, or enclosure. An example of a Full Air Transport Rack (ATR) Long VME enclosure 139, or case, having a standard footprint dimension for receiving cards, such as the PMM 12, is shown in FIG. 5 where the VME enclosure cover 152 has been removed to shown ten installed PMMs 12. Since the commercially available VME enclosures are already designed to comply with MIL specifications for shock, vibration, and temperature, this method utilizes the existing designs of VME rugged enclosures that are commercially available and provide a modular configuration for the PMM. The VME form factor provides a physical packaging for the PMM that is already accepted by the military as rugged, modular, and easily integrated into vehicles, aircraft, watercraft, etc.

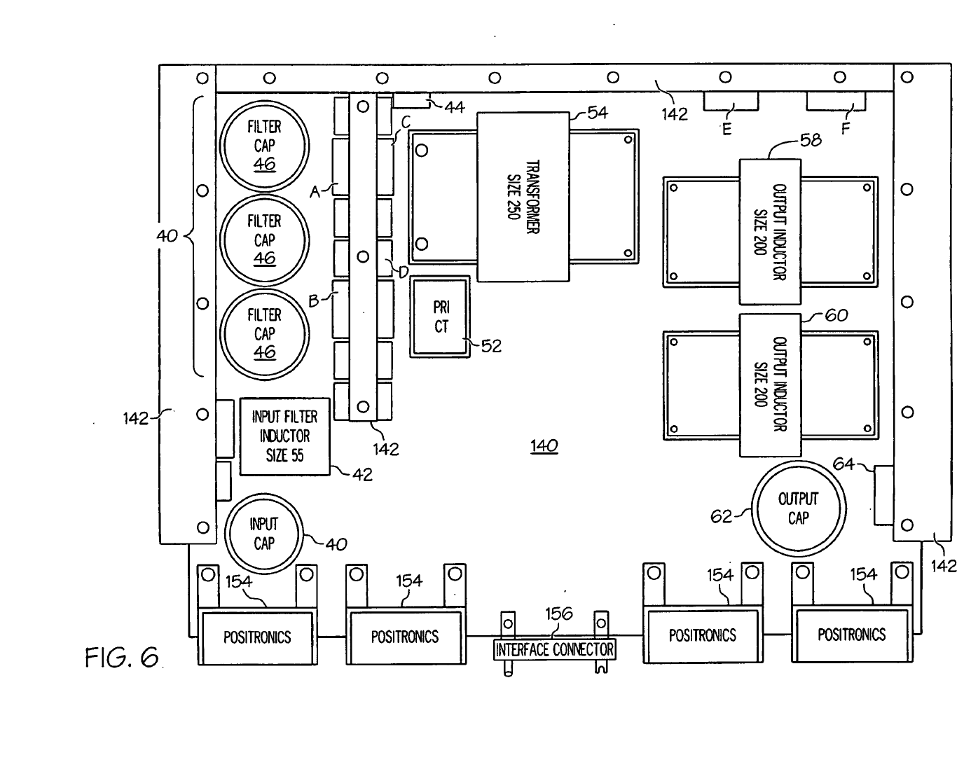

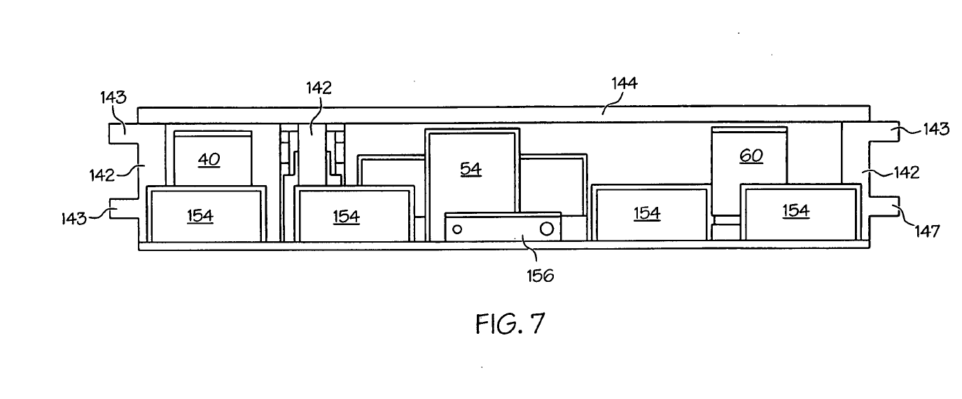

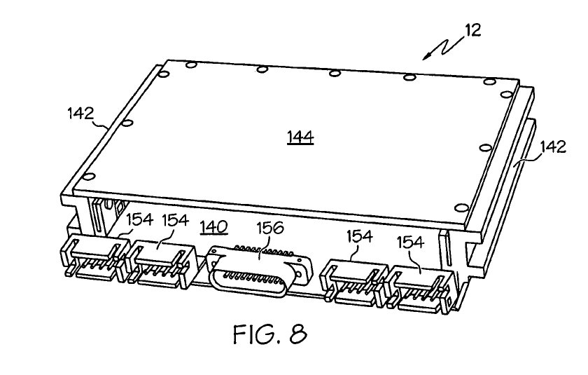

As best seen in FIG. 6, the invention contemplates that the PMM circuit components, which are capable of 1 kW output, are mounted upon a VME form-factor card 140 that utilizes a double the normal slot width that is 1.6 inches wide, instead of a single slot width of 0.8 inch. A machined aluminum heat sink 142 is affixed to the perimeter of the board. The heat sink 142 provides physical strength to the PMM card 140, holds the card against an enclosure (not shown) with adjustable clamps, and transfers heat from the board components into the enclosure. FIG. 6 shows a plan view of the PMM card 140 with component placement while FIG. 7 shows a side view of the PMM card. Components shown in FIGS. 6 and 7 that are similar to components shown in the other drawings have the same numerical identifiers. As shown in FIG. 5, three capacitors are connected in parallel to form the input capacitor 40 for the PMM. A perspective view of the assembled card is shown in FIG. 8.

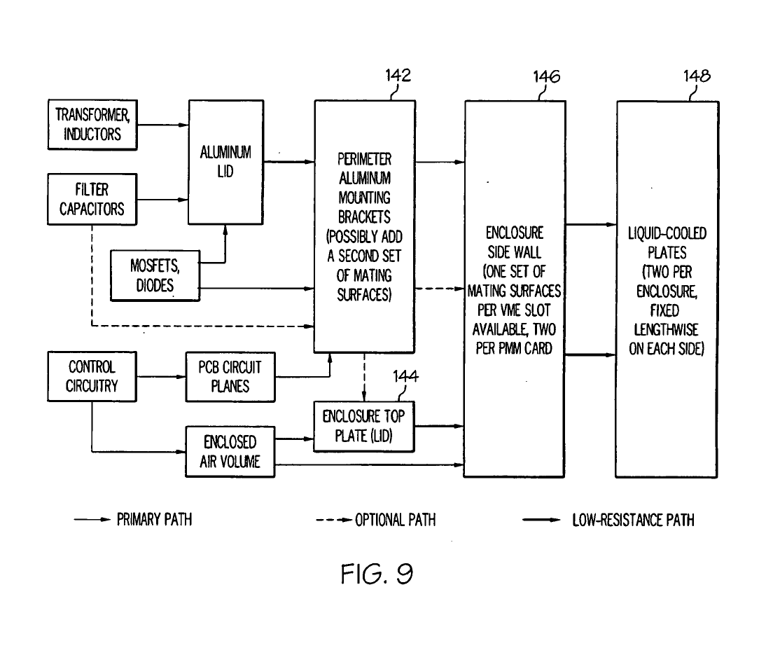

All through-hole semiconductors that generate an appreciable amount of heat are mounted onto one of the four aluminum pieces 142, or brackets, that form the board heat sink with three of the pieces extending around the perimeter of the card 140 and the fourth piece extending across the card. The heat sink pieces that are attached along the sides of the card 140 have two extending ribs 143 that are received in corresponding slots formed in the sides of the PMM enclosure 139, as described below. The transformers, inductors, and capacitors that are included in the PMM 12 are provided a heat sink by means of a formable, sponge-like, heat sinking pad (not shown) that is disposed between the individual components and an aluminum cover 144 for the PMM 12. The cover 144 transfers heat from the components heat sinkable by their top surfaces into the perimeter heat sinks. FIG. 9 illustrates the heat flow for the PMM card components from the components to the perimeter mounting brackets 142 and cover 144 to a side wall 146 of the PMM enclosure 139 and cooling plates 148, which may be either liquid or air cooled.

The invention further contemplates that a plurality of individual PMM cards 112, each or which is capable of 1 kW output, can be connected in parallel as a Multipurpose Electric Power Supply (MEPS) for increased power output. Each PMM card 12 is assigned a control method and regulation set point by the supervisory controller 36. The microcontroller 80 onboard each PMM card then assigns an open-loop analog set point to the UCC3895 phase shift controller 70, for the case of current regulation, or completes the closed loop control path, for the case of voltage control, to satisfy the supervisory command. The PMM cards 12 are linked to the supervisory controller 36 via a first CAN network and are also linked to each other by a second CAN network (not shown). The first CAN network carries the message traffic of the supervisory controller 36, a master PMM card, and the other CAN nodes in the MEPS unit. The PMM cards use the second CAN network to select the master PMM card, which is the PMM card with the lowest CAN address. Once the master PMM card is selected, the remaining cards become PMM slave cards and the second CAN network is used to communicate regulation methods, set points, and faults between the slave and master PMM cards. In the event that the master PMM card fails, the next lowest address PMM card becomes the master card. This reassignment of the master PMM card occurs after a minimum delay passes with no messages sent by the previous master PMM card.

The EPSM VME enclosure 139 as shown in FIG. 5 and described above is capable of holding 10 PMM cards which can provide up to a maximum of 10 kW output power. Greater total output power may be achieved by connecting multiple EPSM units in parallel (not shown). The VME standard Full ATR Long rugged enclosure 139 can hold up to 15 single-slot VME cards. Since the VME enclosure 139 normally includes a power supply, which is not needed for the PMM cards, removing it frees up an additional five slots to provide 20 VME slots for the 10 PMM cards. Each pair of VME slots receives a pair of the ribs 143 extending from the heat sink perimeter pieces 142. The enclosure 139 also includes a backplane (not shown) that connects the fuel cell and battery bus cables to each of the PMM cards along with the supervisory CAN network and enable signal. Each PMM card 12 has five connectors that plug into the enclosure backplane. The four power connectors, which each have eight pins and are labeled 154 on FIGS. 6 through 8, connect fuel cell positive and negative and battery bus positive and negative. All eight pins on the four power connectors are electrically the same connection. The exception is the first pin on the fuel cell positive terminal, which goes to a 100 ohm pre-charge resistor. Pin one on each power connector is slightly longer that the other pins and will connect first when the card is inserted into the VME enclosure. This provides a method to pre-charge the input filter capacitors to the fuel cell voltage level, thus avoiding a spark that would otherwise damage the connector pins or other components. The fifth connector, which is labeled 156 on FIGS. 6 through 8, is a multi-pin connector for the electronics interface.

As described above, the PMM enclosure 139 can be either liquid or forced-air cooled. Air cooling in accomplished by installing fins 148 onto the exterior sides of the VME enclosure 139 with a sheet metal cover (not shown) to create an air pathway. Forced air is then blown into the rear of the case, removing heat from the fins, and exiting the front of the case. Alternately, the fins and sheet metal shrouds may be removed and four cold plates (not shown) installed in their place. Each cold plate contains a ⅜ inch inside diameter copper pipe pressed into a ½ inch aluminum plate. The four cold plates are plumbed in parallel with each other, giving maximum flow with minimum pressure drop. The invention contemplates that the MEPS provides six gallons per minute of no more than 50° C. water/glycol mixture to remove to maximum of 1 kW dissipated heat while the 10 PMM cards are at full load; however, the invention also may be practiced with other cooling fluids and flow rates. Each PMM card is approximately 90% efficient.

In summary, the PMM 12 described above incorporates the electrical features unique to the operating characteristics of fuel cells, such as, for example, input current and voltage regulation, with a capability to charge a battery bus, inside a rugged chassis already in use aboard military vehicles. The inventors believe that the PMM 12 is the first available rugged, scalable, modular, military-rated for shock, vibration, and electrical specifications, DC to DC converter built specifically with fuel-cell integration and battery-charging in mind. While some presently available products may contain one or several of these features, such as a military-rated DC-DC converter that is not modular or liquid cooled, none of them contains all of the features. The PMM 12 is able to regulate the amount of power drawn from the fuel cell, which, in turn, sets the amount of hydrogen consumed by the fuel cell. This electrical regulation of the fuel cell's operating point serves to control the internal physical states of the fuel cell reformer and keep it operating at the best emissions, efficiency, noise, etc. levels possible. The PMM 12 is also capable of following a charge profile, via voltage or current regulation, for the 24 VDC battery bus that is popular in present military systems. This allows the battery bus 34 to be maintained by the PMM charging algorithm while the PMM 12 tolerates the military-rated transient load conditions. The PMM 12 provides electric isolation between the fuel cell, battery bus, and CAN communication for increased safety and decreased electrical noise or EMI interference while also providing voltage and current limits to protect the fuel cell and the batteries. To maintain a high physical reliability, the PMM 12 is integrated into a ATR rugged chassis similar to those used for computer systems in military applications today. The rugged VME chassis has proven to meet military-rated shock, vibration, and temperature, from the manufacturer's design, to provide a secure packaging solution for the replaceable and interchangeable PMM cards. While the EPSM has been described above as including 10 individual PMM circuit cards, with each PMM card rated at 1 kW output power, less circuit cards may be included in a particular EPSM, or with a different enclosure; more than 10 PMM circuit cards may be included in a particular EPSM.

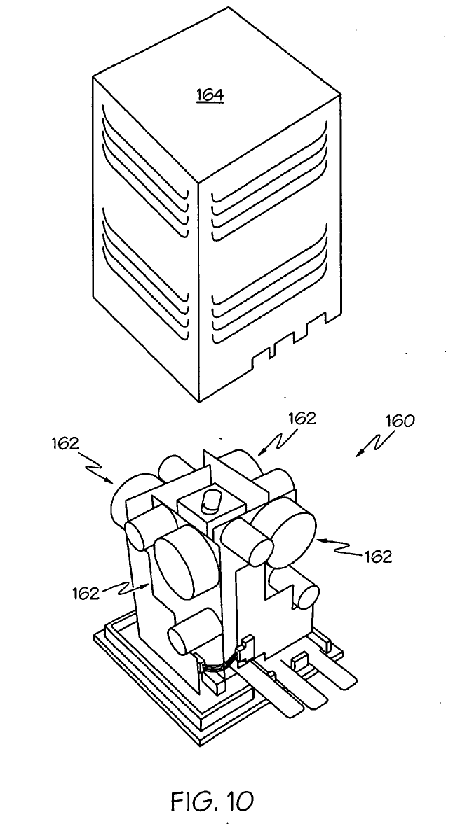

The present invention also contemplates an alternate embodiment of the PMM that is a switching regulator with special control circuitry allowing for an adjustable current-limiting level. The alternate embodiment of the PMM consists of two or more switching power regulators with each power regulator providing an equal share of the total load current. The switching power regulators connect to a backplane holding input and output bus conductors and a cooling assembly. Paralleling the load-sharing, power regulators make it possible to scale the power levels of a system to nearly any level. Incorporating redundant regulators into the design of a PMM also allows for higher reliability requirements to be achieved. Connecting the same switching regulators into configurable backplanes allows for far greater range in mechanical versatility by making a wide variety of cooling options to become available, i.e., fluid, heat pipes, or convection. Referring again to the drawings, there is shown in FIG. 10, a PMM module 160 that includes four alternate embodiment regulator PMM's 162. The module is received by a louvered enclosure 164. Each PMM 162 is independently controlled and capable of 62 A each for a total power output of 250 A at up to a 28 VDC battery charging level. The total power output of the module is up to 7 kW.

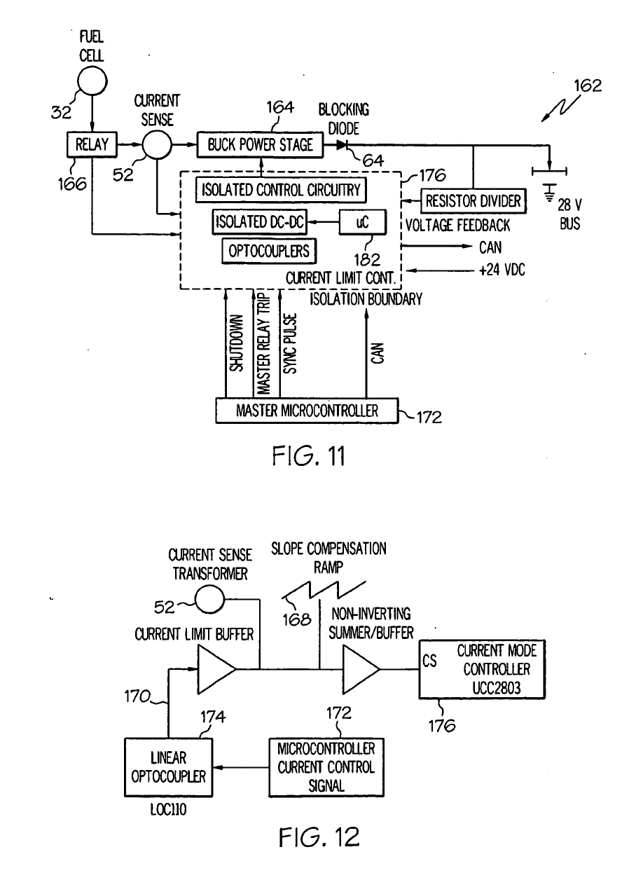

The overall design of the alternate embodiment PMM 162 is illustrated in FIG. 11 as a functional block diagram where components that are similar to components shown in the preceding drawings have the same numerical identifiers. While a single PMM 162 is shown, a plurality of such modules may be connected in paralleled current-mode controlled PMM regulator circuits operating at a fixed frequency. The individual regulators can be isolated by means of any specific switching regulator topology; however, a conventional buck power stage 164 is shown in FIG. 11 as the switching regulator. When multiple modules are utilized, each of the paralleled regulators is programmed to have a matching peak current limit level. Each switching regulator 164 is connected through a current sense transformer circuit 52 and a control relay 166 to a fuel cell 32. The current sense transformer 52 and its associated circuitry sets the maximum switching current level. The result is a well-known ramp on a step representing the current through an output filter inductor (not shown). As shown in FIG. 12, the output of this signal is summed with two other signals: (1) an appropriate level of slope compensation 168 needed for stability in current-mode control; and, (2) a DC offset 170. The circuit shown in FIG. 12 provides the DC offset which is changed dynamically by an external microcontroller 172. The external microcontroller 172 is isolated from the PMM by a linear opto-coupler 174. Scaling and summing a DC offset into the sensed current signal allows the current limit of a PWM, or current mode controller, 176 that is shown in FIG. 12 to be reduced from its maximum value. As also shown in FIG. 12, the circuitry performing this function is a non-inverting op-amp summing circuit. The summed signals are: the sensed inductor current, the AC coupled current-mode slope compensation, and the DC control signal. Incorporating this circuitry on each switching regulator 172 allows for a separate external controller 172 to adjust the desired maximum current limit of the PMM 162 to match the hydrogen levels available to the fuel cell 32. This signal can be digital or analog and is scaled to match the full-scale range of the PWM controller's current comparator. The scaled signal appears at the Current Sense (CS) input port of the PWM controller 176 as a signal between 0V and 1.0V, full-scale range. Load demands in excess of the new current limit are supplemented with batteries (not shown) external to the output of the PMM 162, in which case, the PMM can also act as a controllable battery charger.

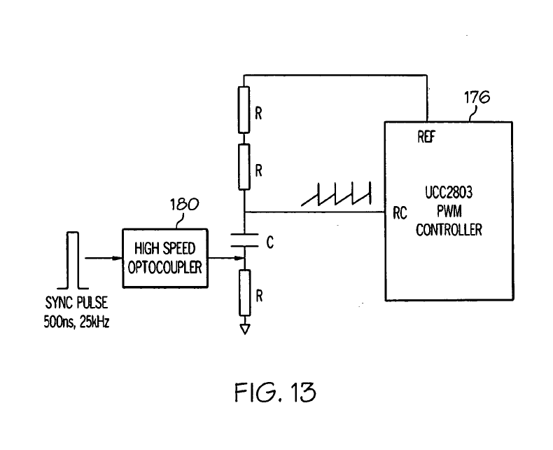

Components and circuitry utilized for the PMM 162 can be digital and/or analog to set and control the current limiting characteristics and performance from the PWM controller 176. When multiple regulators are operated in parallel within the Power Management Module, the PWM timing ramps are synchronized to a common narrow 250-500 ns pulse added to their positive-going timing ramps, as illustrated in FIG. 13. This sync pulse is provided by a generator internal to the PMM. The modified timing ramp includes spikes generated by the timing pulses. While a 25 kHz synchronizing pulse is shown in FIG. 13, it will be appreciated that the invention also may be practiced with synchronizing pluses having different frequencies. A high speed opto-coupler provides isolation between the PWM controller 176 and the synchronizing pulse generator (not shown).

Closed-loop system control is possible between the switching regulators and the external master microcontroller. The closed loop automatically maintains power levels to a load and batteries while keeping the load demands on the fuel cell within its safe operating range. Using closed loop control safeguards not only the fuel cell but the load and the batteries as well. Use of digital microcontrollers embedded on each regulator prevents high currents from overcharging the batteries and maintains the switching circuit in current-mode control. By automatically limiting the sourcing current flow based on the battery output voltage an excellent float charging of the batteries is achieved

The invention contemplates that a separate control board 182 is used on one of the high-current switching regulators of the PMM 162. The circuitry on the control board 182 is isolated from the switching power circuitry to minimize noise coupling. The control board 182 monitors input and output currents, input and output voltages, transistor temperature and contains isolated CAN bus communications between a system master controller and all other switching regulators in the PMM system.

The PMM 162 provides specific functions of dynamic current limiting by external control with an input voltage range of 80 VDC down to 28 VDC. The present invention is differentiated by its functionality, versatility, and overall reduced size when compared to commercially available products. An expanded version of the PMM 162 includes separate battery connections with dedicated charger control and/or an integrated inverter to supply AC power (not shown).

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A control circuit for management of a fuel cell comprising:
at least one sensor adapted to be in communication with a fuel cell and operative to monitor an operating condition of the fuel cell and to generate an output signal; and
a regulator circuit that is connected to said sensor, said regulator circuit operative to generate a control signal that is a function of said sensor output signal; and
a current regulation circuit adapted to be connected between the fuel cell and a load, said current regulation circuit connected to said regulator circuit to receive said control signal, said current regulation circuit responsive to said control signal to regulate the operation of the fuel cell.

2. The control circuit according to claim 1 wherein said current regulation circuit is a pulse width modulated current limiter circuit.

3. The control circuit according to claim 2 wherein said sensor is operative to determine the rate of fuel delivery to the fuel cell and said control signal generated by said regulator circuit is an offset voltage that is a function of said rate of fuel delivery to the fuel cell and further wherein said pulse width modulated current limiter circuit is operative to limit the current flowing to said load such that the load current does not exceed the capacity of the fuel cell being supplied at said sensed fuel supply rate.

4. The control circuit according to claim 1 wherein said sensor is operative to determine the rate of fuel delivery to the fuel cell and said control signal generated by said regulator circuit is an offset voltage that is a function of said rate of fuel delivery to the fuel cell and further wherein said current regulation circuit includes at least two parallel connected pulse width modulated current limiter circuits, both of said pulse width modulated limiter circuits being connected to said regulator circuit and responsive to said offset voltage to limit the current flowing to said load such that the load current does not exceed the capacity of the fuel cell being supplied at said sensed fuel supply rate.

5. The control circuit according to claim 4 wherein each of said pulse width modulated current limiter circuits includes a buck power stage.

6. The control circuit according to claim 5 further including a microprocessor for closed loop control of said pulse width modulated current limiter circuits.

7. The control circuit according to claim 1 wherein said current regulation circuit includes:
a dc to ac converter connected to said regulator circuit and having a dc input that is adapted to be connected to the fuel cell, said dc to ac converter also having an ac output;
a transformer having a primary winding and a secondary winding with said primary winding connected to said ac output of said dc to ac converter; and
an ac to dc converter connected to said regulator circuit and having an ac input connected to said secondary winding of said transformer.

8. The control circuit according to claim 7 wherein said sensor is operative to monitor at least one of the current and the output voltage being supplied by the fuel cell and further wherein said dc to ac converter includes a bridge circuit containing a plurality of electronic switches that are selectively closed to convert a direct current into an alternating current.

9. The control circuit according to claim 8 wherein said electronic switches are Field Effect Transistors having gate terminals and further wherein said regulator circuit is connected to said gate terminals of said Field Effect Transistors, said regulator circuit operative to selectively change the Field Effect Transistors between their conducting and non-conducting states to convert said direct current into said alternating current.

10. The control circuit according to claim 9 wherein said ac to dc converter includes a pair of synchronous freewheeling current doubler power buck stages.

11. The control circuit according to claim 10 wherein said synchronous freewheeling current doubler power buck stages include electronic switches which are selectively closed to convert said alternating current into said direct current.

12. The control circuit according to claim 11 wherein said electronic switches in said freewheeling current doubler power buck stages are Field Effect Transistors having gate terminals and further wherein said regulator circuit is connected to said gate terminals of said buck stage Field Effect Transistors, said regulator circuit operative to selectively change said buck stage Field Effect Transistors between their conducting and non-conducting states to convert said alternating current into said direct current.

13. The control circuit according to claim 12 further including an input filter connected between the fuel cell and said dc to ac converter and an output filter connected between said ac to dc converter and said load.

14. The control circuit according to claim 12 further including a microprocessor, said microprocessor operative to provide closed loop control utilizing a phase-shifted PWM control method for the circuit.

15. The control circuit according to claim 14 wherein said microprocessor is adapted to be connected to a supervisory controller, said supervisory controller operative to provide an operating set point to said microprocessor for control of the circuit.

16. The control circuit according to claim 14 wherein said circuit components are mounted upon a circuit card that is received by an enclosure.

17. The control circuit according to claim 16 wherein a plurality of circuit cards is received by said enclosure, each of said circuit cards being connected to a corresponding fuel cell and further wherein said plurality of circuit cards are connected in parallel to increase the total output of the circuit.

18. The control circuit according to claim 17 wherein one of said plurality of circuit cards is selected as a master circuit card with the operation of the remaining circuit cards synchronized with the operation of said master card.

19. The control circuit according to claim 16 wherein said circuit card includes a heat sink attached to at least one edge of said card, said heat sink transferring heat generated from said circuit components to said enclosure.

20. The control circuit according to claim 19 wherein said load is a dc power bus.
